(19) United States
(12) Patent Application Publication
(10) Pub. No.: US 2009/0160271 A1
(43) Pub. Date: Jun. 25, 2009

(54) FLEXIBLE-TUBING MOTOR

(75) Inventors: Thomas Bischof, Illerbeuren (DE); Karl Mack, Luetkirch (DE)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: SycoTec GmbH & Co. KG, Leutkirch im Allgau (DE)

(21) Appl. No.: 12/339,955

(22) Filed: Dec. 19, 2008

(30) Foreign Application Priority Data
Dec. 20, 2007 (EP) EP 07076114.3

(51) Int. Cl. H02K 9/00; A61C 1/05

(52) U.S. Cl. 310/52; 433/132

(57) ABSTRACT

The present invention relates to a flexible-tubing motor for coupling dental instruments, containing a motor with a stator, with a rotor as well as with a coupling for coupling dental instruments, as well as a flexible tubing, wherein media conduits are led through the flexible tubing for the supply of media to the dental instrument, and the flexible tubing at the end which is distant to the motor may be connected to a drive and control unit for supplying and regulating media. The flexible-tubing motor according to the invention is distinguished by a very compact constructional manner, by which the operator is permitted to work without tiring, even over a long period of time.

### CROSS-REFERENCE TO RELATED APPLICATIONS

This application claims the benefit under 35 U.S.C. § 119 of European Patent Application No. 07 076 114.3 filed Dec. 20, 2007, which is incorporated herein by reference in its entirety.

This application is related to co-pending and commonly assigned U.S. Application Ser. No. __/______ entitled “ELECTRIC MOTOR FOR DENTAL OR MEDICAL INSTRUMENT,” which claims the benefit under 35 U.S.C. §119 of European Patent Application No. 07 076 113.5, filed Dec. 20, 2007. Each of the foregoing U.S. and European patent applications is incorporated by reference herein in its entirety.

### TECHNICAL FIELD

The present invention relates to electric motors for the drive of dental instruments.

### BACKGROUND

Dental drive systems usually comprise a dental instrument for receiving a rotating tool, as well, as a drive motor which may be coupled via a quick-coupling (e.g. a coupling according to DIN ISO 3964), to the instrument. The motor in turn is preferably connected via a further quick-coupling to a flexible supply tubing, wherein the flexible supply tubing contains the electricity supply for the electric motor, as well as media supply conduits for the water and air. These are therefore usually three individual components which are coupled to one another in a pluggable manner according to the state of the art. The disadvantage of these common arrangements is however the high weight as well as the unfavorable position of the center of gravity of the electric motor. The operator (for example a dentist or dental technician), grips the system mostly in the region of the motor. A more rapid tiring of the operator occurs on account of the disadvantageous situation mentioned above, with regard to the weight or the position of the center of gravity.

### SUMMARY

It is therefore the object of the present invention to provide a system for the drive of a dental instrument, which is lightweight and is compact, in order thus to ensure a simplified working for a dentist or dental technician, even over a long period of time.

This object is achieved by a flexible-tubing motor according to claim 1.

According to the invention, a flexible-tubing motor for coupling dental instruments is provided, containing a motor with a stator, with a rotor and with a coupling for coupling dental instruments, as well as with a flexible tubing, wherein media conduits are led through the flexible tubing to the dental instrument for supplying media, and the flexible tubing at the end which is distant to the motor, may be connected to a drive and control unit, for supplying and regulating the media. The electric motor hereby is connected to the flexible tubing without a separable coupling. This means that in normal operation, a decoupling of the motor from the flexible tubing, for example by the dentist, is not possible. This is only possible after the respective housing is opened. Moreover, it is also not possible, for example for disinfecting the motor, to simply release a coupling. Instead of this for example, the complete arrangement (motor including flexible tubing) may be disinfected as a whole, and this also ensures a greatest possible disinfection of the complete arrangement.

The advantage of the “integrated flexible-tubing motor,” thus the idea for the first time of the flexible tubing being connected to the motor unit, above all lies in a compact total system.

It is possible (in particular with the high-performance and small motors according to the invention), to keep the flexible-tubing motor very short and small, in particular the unit around the motor held by the operator in the hand. It is thus possible to construct a short and lightweight ergonomic system, which has a full compatibility to dental instruments which are common on the market at present (e.g. with a coupling according to DIN ISO 3964) and hereby has no limitations with regard to the power, rotational speed and the torque.

This for example is expressed by the fact that the ratio I_{G} of the housing of the flexible-tubing motor from the abutment of the coupling for dental instruments, up to the end of the housing on the flexible tubing side, including the guide sleeve, in relation to the largest possible radial dimension (D_{G}) of the housing of the flexible-tubing motor, is between 80/19 and 45/23, preferably between 65/19 and 60/23.

A further advantageous further formation envisions the torque of the electric motor in a rotational speed range of between 10 r.p.m and 50,000 r.p.m, being continuously more than 1 Ncm, preferably more than 1.2 Ncm and particularly preferably more than 1.5 Ncm. In this way, one succeeds in achieving very high-power motors while retaining the “usual” diameter dimension. “Usual diameter dimension” is to be understood as the largest radial extent of the handling unit, and this usually fits to corresponding cross sections of instruments, e.g. according to DIN ISO 3964. Despite this, the length of the motor or in this way, also of the housing of the flexible-tubing motor, is also relatively small. It is between 30 and 55 mm from the abutment (the abutment edge) of the coupling, towards the dental instrument (thus not from the tip of the coupling, but from the abutment edge), to the end of the housing. With a guide sleeve for the flexible tubing, which connects on the flexible tubing side, the total length may increase to 45 to 80 mm (thus calculated from the abutment edge to the end of the guide sleeve).

The mentioned lengths hereby relate in particular to the diameter of the housing of the flexible-tubing motor at the largest location between 19 and 23 mm.

It is clear from this, that even with these small dimensions, for example with the new motor according to the invention, which comprises a Gramme stator winding, on the one hand one may provide a compact apparatus, which however on the other hand still has very large torques.

By way of the fact that a torque of more that 1 Ncm is constantly present in each case, for example in the region between 10 r.p.m and 50,000 r.p.m, one may carry out a dental operation even at the lowest of rotational speeds, without the drill “blocking,” even with this relatively compact instrument with the application of large-volume drills in the dental instrument. This is not possible with compact apparatus according to the state of the art, since these as a rule may not muster the required torque.

The whole arrangement may be created in a more compact and lighter manner by way of making do without a separable coupling in the transition region from the electric motor to the flexible tubing. Moreover, there are no error sources on account of an additional coupling in this region. Finally, losses of media do not occur, which seep into this region due to the otherwise common couplings. For example, a pressure loss of air or a light loss due to light scatter does not occur.

The flexible-tubing motor according to the invention envisions the electric motor being connected to a flexible tubing in a coupling-free manner, wherein the flexible tubing at the end which is distant to the electric motor, comprises a drive and control unit for supplying and regulating media. In other words, media conduits run through the flexible tubing, which then run in a coupling-free manner up to the coupling for the dental instrument, and for this reason one may make do without at least one coupling, which usually lies between the flexible tubing piece and the motor which connects to this by way of a coupling.

In a particularly preferable embodiment, a fiber-optic (media conduit for leading light) may yet run through the flexible tubing. This permits a light source to be arranged in the drive and control unit, and this light is then led through the flexible tubing and the motor towards the dental instrument. In this way, the flexible-tubing motor according to the invention may be constructed even smaller, since for example no light source needs to be attached in the region of the motor. Moreover, the advantage results, that the operator is not unpleasantly influenced by the heating caused by the light source. Finally, with the coupling-free flexible-tubing motor, it is particularly advantageous that no coupling is provided at the transition from the flexible tubing to the motor, said coupling leading to a loss of brightness due to scatter light in the case of a fiber optic.

The flexible tubing according to the invention may be designed practically infinitely long, the greatest length of the flexible-tubing motor (thus flexible tubing including electric motor from the tip of the coupling to the dental instrument, up to the run-out of the flexible tubing into the drive and control unit) may be between 1 m and 3 m without further ado.

The easy handling for the operator, which is due to the fact that the flexible-tubing motor has favourable dimensions for the hand of the operator, is to be emphasised with regard to the integrated construction manner.

The ratio of the length of the housing of the flexible-tubing motor from the abutment edge of the coupling for dental instruments, up to the end of the housing of the flexible-tubing motor, said end being on the flexible tubing side, to the largest radial dimension of the flexible-tubing motor (usually this is to be understood as the diameter of the flexible-tubing motor at the “thickest” location, and in the case that this is not a circle, then it is to be understood as the largest diagonal in a cross section perpendicular to the direction of a drive shaft mounted in the electric motor), is between 55/19 and 30/23, preferably between 45/19 and 40/23.

The absolute length of the housing of the flexible-tubing motor from the abutment edge of the coupling for dental instruments, up to the end on the flexible tubing side, is between 30 mm and 55 mm or up to the end of a guide sleeve connecting to the housing, is between 45 mm and 80 mm.

The largest diameter (D_{G}, see FIG. 5) of the housing of the flexible-tubing motor is preferably between 19 and 23 mm. In this way, the apparatus is pleasant to grip, and a relatively “harmonic” transition to common dental instruments which also have roughly the same diameter range, results.

In a further formation, a Gramme stator winding divided into several sections is provided as a stator winding, wherein media conduits run at least in regions, between individual sections of this stator winding.

“Gramme stator winding” in the context of this application, is to be understood in that the stator comprises a yoke winding or a ring winding according to Gramme. The advantage of this technology lies in the fact that the conductors run essentially in the axial direction in the magnetically active region, which faces the permanent-magnetic rotor magnet, as well as in the passive region at the back of the stator. In this way, it is possible to lead the media in the diameter region of the winding on the inside between the rotor and the stator yoke, as well on the outside in the region of the leading-back of the winding. Ideally, this is effected between the individual sections of the stator winding mentioned above.

In other words, the winding wires with this winding, are wound around the preferably annular stator core and hereby (at least on the radial inner side as well as radial outer side of the stator core) are essentially parallel to the shaft. According to the invention, hereby, an angular deviation is however possible.

With the inventive leading of media conduits through the stator (and hereby possibly also the region encompassed by the stator yoke), the stator is rendered fully usable for media passages with electric motors for the drive of dental instruments.

This for starters, leads to the extent of the motor or of the hand apparatus, which accommodates the dental instrument, being able to be kept small in the radial direction.

A further great advantage is the fact that the electric motor (i.e. the stator magnet as well as the rotor magnet) may be kept very short in the direction of the rotor/the rotor shaft, on account of the stator winding according to the invention.

In this way, according to the invention, the constructional size is reduced in the longitudinal direction as well as in the radial direction, and the advantages of operation without tiring result for the operator.

The motor according to the invention, may be advantageously designed as a permanent magnet synchronous motor or as a d.c. motor without collector (BDLC-motor). In this way, a relative wear-free arrangement results, in particular with the high rotational speed applications which are required in the dental field.

The sections of the stator winding in each case advantageously represent individual coils. Hereby, in each case, diametrically opposite individual coils may be connected to one another in each case into a coil pair, and be switched to a phase. A relatively good efficiency with a compact construction manner and a low wear results by way of this, with still acceptable construction costs.

The individual coils or the individual sections are hereby preferably wound in a multi-layered manner. The individual coils or sections themselves are preferably not arranged in an overlapping manner, in order in particular to save radial construction space.

The stator preferably comprises a yoke ring, wherein this yoke ring is preferably enclosed by a coil body of the stator. The manufacturing costs are minimised by way of this multi-part modular constructional shape, and coil bodies of different types may be applied, which are adapted to the respective media conduits, i.e. to their size or course.

The stator winding hereby is wound around sections of the yoke ring or coil body, which are essentially shaped in the manner of an annulus segment. The yoke ring in turn is constructed in the context of an inexpensive and modular construction of several layers of a sheet-metal. Preferably, the stator winding may be filled out or cast out with a resin material or with a plastic material.

It is very advantageous for the electric motor according to the invention, despite its very compact constructional size, to comprise a coupling, which is common in practice, for receiving a dental instrument to be driven, in particular a coupling according to DIN ISO 3964, which thus permits the attachment of existing and inexpensive instruments.

The yoke ring of the electric motor may be preferably enclosed by the coil body radially to the outside or radially to the inside. Hereby, radial protuberances of the coil body may be located between the sections of the stator winding, in order to achieve a particularly well geometrically defined leading of the media conduits in this, and hereby to also obtain an acceptable temperature drop to the possibly warmer stator winding. The media conduits hereby run preferably in the longitudinal direction of the shaft through the stator or the coil body. In particular, hereby, the heating of the media (air or water) may be neglected due to the short constructional arrangement.

The media conduits may preferably be media conduits for leading through water, air (in particular compressed air) or also light.

The ratio of the size extent of the stator radially to the shaft, to the greatest extent of the stator in the direction of the shaft (longitudinal direction), is preferably between 0.8 and 5, particularly preferably between 1 and 3, in a very particularly preferred embodiment is between 1.2 and 1.6.

Hereby, the extents of the stator (in the radial or axial direction) which are mentioned above, are to be understood as the largest dimensions of the respective winding sections.

Preferably, the ratio of the greatest extent of the stator radially to the shaft, to the greatest length of the rotor magnet (length of the rotor magnet in the direction of the shaft) lies between 1 and 6, preferably between 1.1 and 2, particularly preferably between 1.6 and 1.8.

In this way, it is clear that the motor according to the invention may be manufactured in a particularly short construction manner for its power class. “Greatest extent of the stator radially to the shaft” is again the largest extent of the electrically effective parts, preferably of the stator winding. “Greatest length of the rotor magnet in the shaft direction” is also only to be understood as the section with actual permanent-magnetic material, thus without connecting (for example magnetised in later operation) metal sections.

### BRIEF DESCRIPTION OF THE DRAWINGS

The invention is now explained by way of several figures. There are shown in:

FIG. 1 is a view of an electric motor according to the invention, which on the left comprises a coupling for attaching a dental instrument.

FIG. 2 is a view which is partly sectioned away, of a stator contained in the flexible-tubing motor.

FIGS. 3a to 3c are various views of a flexible-tubing motor according to the invention.

FIG. 4 is a representation of the transition from the flexible-tubing motor according to the invention, to a dental instrument.

FIG. 5 is a cross section of a flexible-tubing motor.

### DETAILED DESCRIPTION

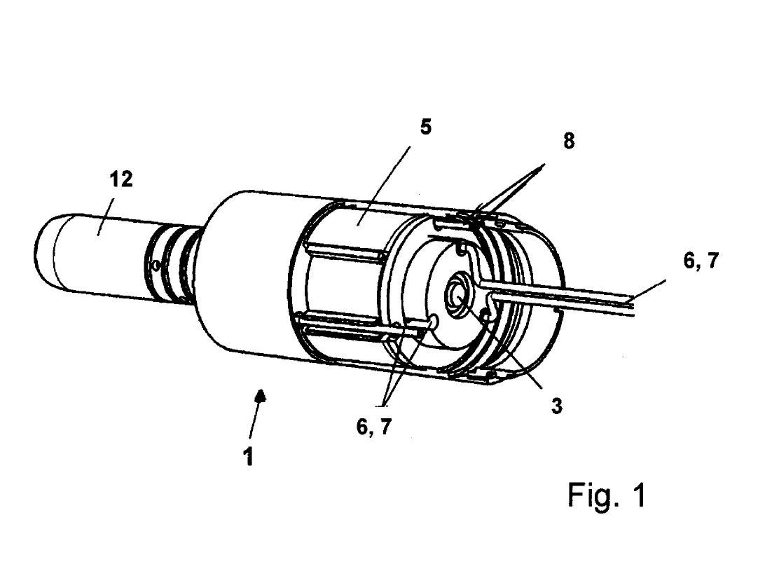

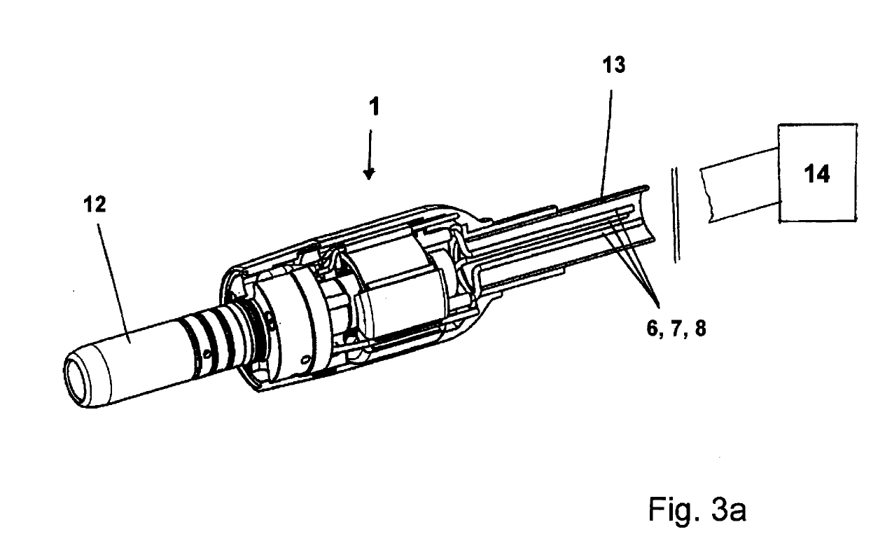

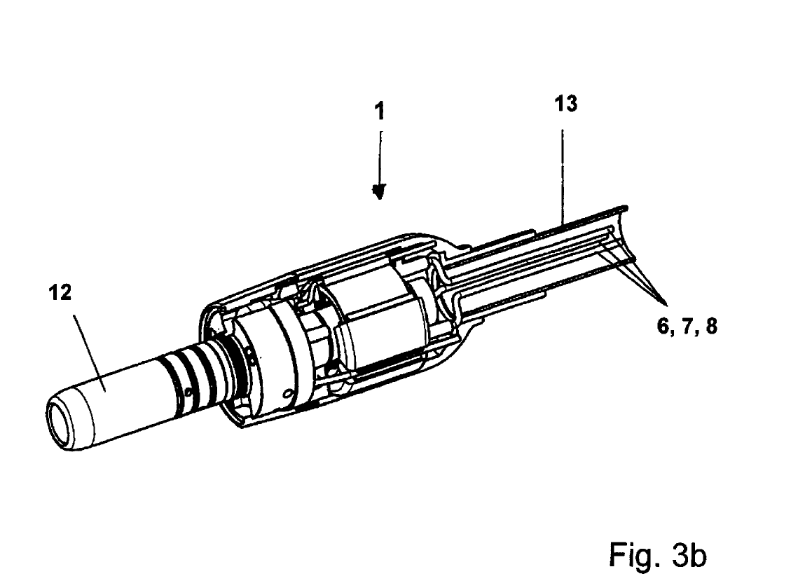

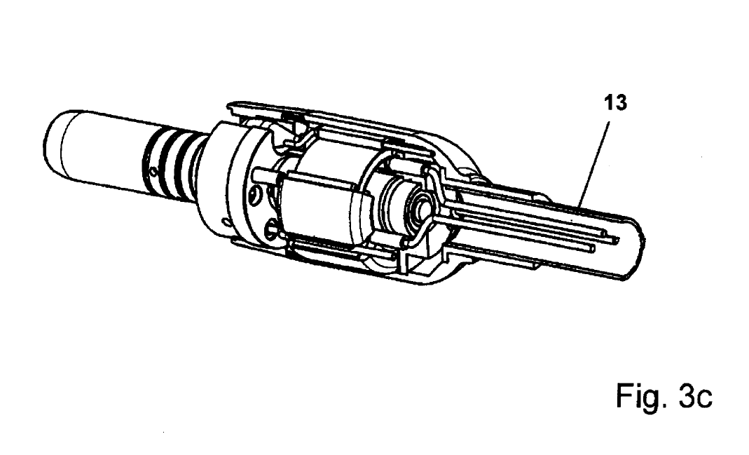

FIG. 1 shows an electric motor 1 according to the invention. This is accommodated in a housing, to which a coupling 12 according to DIN ISO 3964, for the connection of dental instruments, is attached. The electric motor 1 itself comprises a shaft 3 which is connected to a rotor magnet 4. A stator 5 is concentrically arranged around this, and media conduits 6 and 7 (for water and air) and light (media conduit 8) run through the stator, i.e. they no longer need to be led outside the stator. The “media conduit for light” may either be a fiber optic (e.g. glass fiber), alternatively also an electricity supply to a light or light diode, which is attached close to the coupling. “Through the stator” or “within the stator” hereby it to be understood in that the media conduits run radially within electrically effective regions of the stator, here radially within the largest dimensions of the stator windings. The media conduits or electrical supply leads for the motor according to the invention run through a flexible tubing which is no longer shown on the right in FIG. 1, which may either be firmly connected to the electric motor, or may be coupled to this via the coupling. The media conduits hereby project preferably radially inwards (see FIG. 3) on the side which is distant to the coupling 12, in order in this region to provide a flexible tubing with a small diameter as soon as possible after the end of the electric motor.

The electric motor 1 is a permanent magnet synchronous motor, here a d.c. motor without collector (BLDC motor).

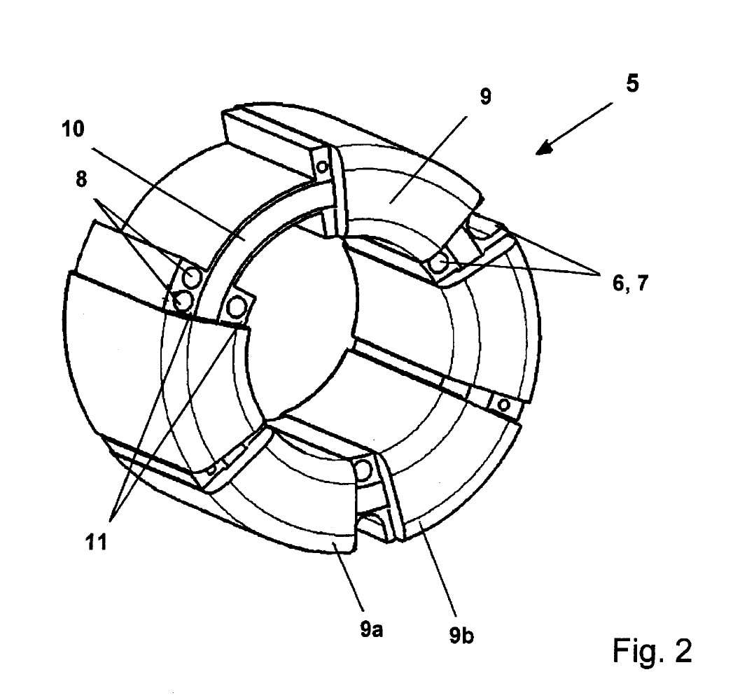

FIG. 2 shows a detailed, partly freely sectioned construction of the stator 5. This stator comprises a stator winding 9 which is wound according to Gramme, i.e. around the coil body 11 which radially encloses a yoke ring 10 belonging to the coil body. The winding wires hereby run around the outer ring formed by the coil body, or around the annular stator core. In the representation shown in FIG. 2, the winding 9 hereby is subdivided into several sections, which in each case represent annulus segments. These annulus-segment-shaped sections (for example a first section 9a or a second section 9b) are preferably represented as individual coils. The winding wires of these individual coils are arranged essentially in the running direction of the shaft 3, (this runs essentially aligned to the coupling 12, see FIG. 1). The course of the winding wires along the shaft 3 hereby only applies to the radial inner side or radial outer side, and at the end-side the winding wire runs essential radially inwards or radially outwards.

In total, six individual coils 9a, 9b, etc. are provided, wherein the respective diametrically oppositely lying individual coils are connected to one another in each case into a coil pair and are switched to a phase.

The sections 9a, 9b, etc. or individual coils are wound in a multi-layered manner and do not overlap, even in their end regions. The corresponding stator winding is cast with an artificial resin or plastic.

The stator 5 shows the yoke ring 10 which is surrounded radially inwards and radially outwards by the coil body, and the coil body in turn is surrounded by the corresponding winding.

The yoke ring 10 is constructed of several layers of a sheet-metal.

The coil body between the individual sections 9a, 9b, etc. comprises radial raised parts, which run radially outwards or radially inwards (thus to the rotor magnet). In these regions, the passage of the media conduit 8 by light, or of a media conduit 7 by air, or of a media conduit 6 by water, is possible without an unnecessary field influence or thermal influence by the electric motor. Basically, one may lead through an infinite number of media conduits, possible are also electricity supply leads, in the case that the dental instrument should require additional connections here. The media conduits may thus run within or outside a yoke ring. They do not necessarily need to run between individual sections or stator windings, but may also run through the stator winding.

The ratio of the size extent of the stator radially to the shaft (largest diameter region of the stator in FIG. 2, measured as a diagonal of the two radial points of the stator winding which are distanced the most, to the greatest extent of the stator in the direction of the shaft (thus in the longitudinal direction of the shaft, here therefore aligned to the coupling, again here between the regions of the stator winding which are axially distanced the most from one another), is 1.4.

The ratio of the greatest extent of the stator radially to the shaft (here again the largest diameter dimension in the region of the stator winding), to the greatest length of the rotor magnet (only the length of the actual rotor magnet is considered), is 1.6.

FIGS. 3a to 3c show different views of a flexible-tubing motor according to the invention. Hereby, the electric motor 1 according to the invention, which is arranged in a housing, with which the housing on the left side comprises the coupling 12 according to DIN ISO 3964, is connected directly to a flexible tubing 13 on the right side, without yet an additional coupling being provided here. Such a coupling would entail large construction costs, further sources of errors, as well as a greater weight. The media conduits for air, water or light 6, 7, 8 hereby run through the flexible tubing 13 up to a drive and control unit 14. Here, the greatest distance measured from the tip of the coupling 12, up to the run-out of the flexible tubing 13 into the drive and control unit 14, is 2.5 m

It is to be noted that the media conduit 8 for leading through light, which is preferably designed as a glass fiber conduit (alternatively as an electricity supply lead), runs directly from the drive and control unit to the coupling 12 without interruption. A light source which feeds the light into this fiber-optic, is provided in the drive and control unit. In this way, there is no necessity of an additional light source in the region of the electric motor 1, which would require additional construction space or would entail an increased heat dissipation in the region of the hand of the operator. In particular, by way of making do without a coupling between the electric motor and the flexible tubing, one also ensures that this coupling produces no scatter light loss.

With the arrangement shown in FIG. 3a, it is the case of a flexible-tubing motor for coupling dental instruments, containing an electric motor 1 with a stator 5 and with a coupling 12 for coupling dental instruments. Media conduits 6, 7, 8 belonging to the flexible-tubing motor for the supply of media, such as compressed air, water or light to the dental instrument, are led through the flexible tubing 13. The flexible tubing at the end which is distant to the electric motor 1, is connected to a drive and control unit 14 for the supply and regulation of media, for example by way of a plug connection or also by way of a fixed connection. What is essential is that the electric motor 1 is connected to the flexible tubing 13 as one piece and without any separation coupling. This means that in “normal operation,” for example in a dental surgery, the flexible tubing 13 is not to be separated from the electric motor 1, but that this is only possible within the framework of maintenance measures. It is possible to offer a complete unit with “quality guarantee.” In this way, specifically an inseparable unit of the flexible tubing and motor, so that no complications may arise due to incompatible apparatus of different manufacturers.

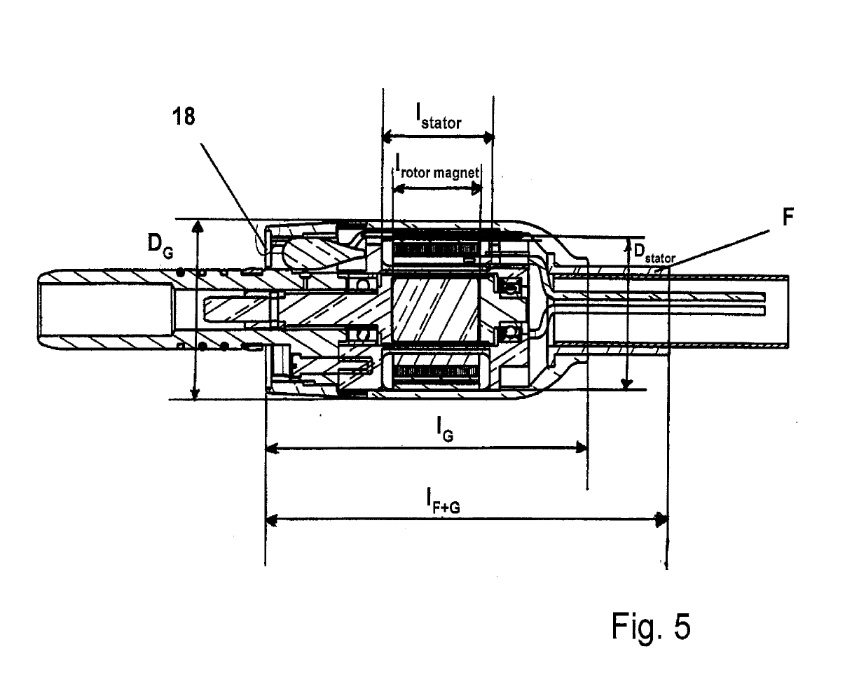

FIG. 5 is referred to for explaining the geometric sizes.

Here, the largest radial dimension D_{G} of the housing 16 of the flexible-tubing motor is 22 mm.

The ratio of the length I_{G} of the housing of the flexible-tubing motor from the abutment edge of the coupling 12 for dental instruments, up to the end of the housing 16 on the flexible tubing side, to the largest radial dimension (D_{G}) of the flexible-tubing motor, is 40/22.

The length I_{G} as an absolute measure is 40 mm, including the guide sleeve 15 it is I_{F+G}=60 mm.

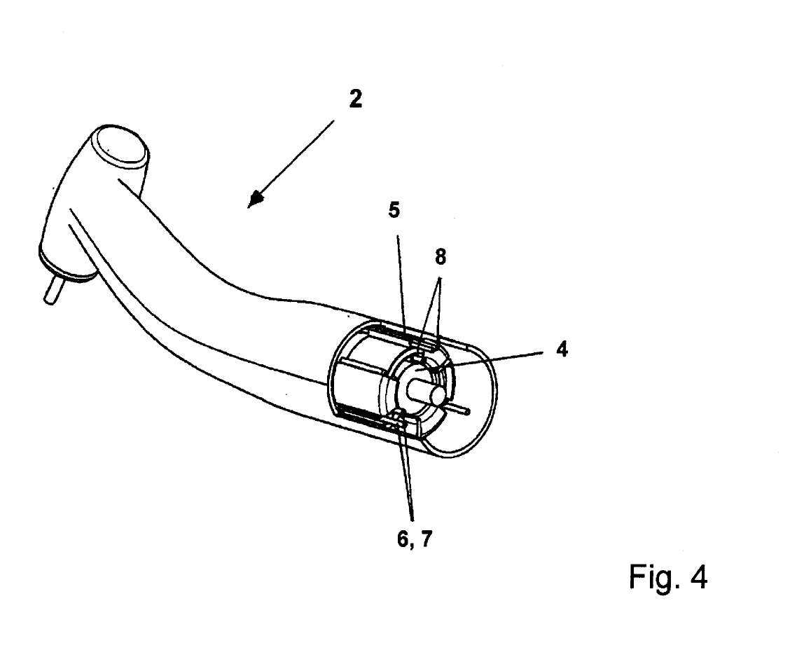

FIG. 4 shows one example of a dental instrument 2 with an integrated electric motor. “Dental instrument” in the context of this application is to be understood to include apparatus which, driven by motor, permits the machining of objects or teeth, preferably by a dentist, a dental technician or corresponding personnel.

FIG. 5 once again, by way of the electric motor shown in the preceding figures, shows different geometric conditions. The electric motor hereby is the electric motor provided with the Gramme stator winding, but this is not to be understood as being limiting, and here, other electric motors may also be applied, which have the power data according to the invention or are similarly compact.

The electric motor installed here has a torque of 1.5 Ncm in the range between 10 and 50,000 rpm.

The left-side coupling is a coupling according to DIN ISO 3964, and this is to be understood only as an example. The abutment edge 18 is to be understood as the mentioned “abutment edge.”

The mentioned diameter and length values or ratio values have already been explained previously in the introductory description and the description of the figures, and here the explanation of the respective lengths is explained in a conclusive manner.

“D_{G}” is to be understood as the largest diameter of the housing 16 of the flexible-tubing motor. “I_{G}” is to be understood as the greatest length extent of the housing, up to the termination of the housing (constructed of metal, in particular titanium or plastic). Hereby, a guide sleeve F is shown concentrically within the end of the housing on the flexible tubing side, and the total length from the abutment edge 18 up to the end of the guide sleeve is indicated at I_{F+G}.

The greatest radial extent of the stator is indicated by “Dₛₜₐₜₒᵣ.” The greatest length of the stator (in the shaft direction or rotor direction or direction of the coupling) is indicated by “Iₛₜₐₜₒᵣ.” The greatest extent of the rotor magnet is indicated by “I_{rotor magnet}.”

The following is claimed:

1. A flexible-tubing motor for coupling a dental instrument, the flexible-tubing motor comprising:
an electric motor including a stator, a rotor, and a coupling for coupling dental instruments;
a flexible tubing;
a plurality of media conduits guided through the flexible tubing for the supply of media to the dental instrument; and
a drive and control unit connected to an end of the flexible tubing distant to the motor for supplying and regulating media, wherein the electric motor is connected to the flexible tubing without a separable coupling.

2. A flexible-tubing motor according to claim 1, wherein the plurality of media conduits includes a media conduit for light disposed through the flexible tube, and wherein a light source is provided in the drive and control unit.

3. A flexible-tubing motor according to claim 1, wherein the flexible-tubing motor has a maximum length from a tip of the coupling for coupling the dental instrument up to a transition of the flexible tubing to the drive and control unit of between 1 m and 3 m.

4. A flexible-tubing motor according to claim 1, wherein the motor stator includes a Gramme stator winding which is radially divided into a plurality of individual sections, wherein at least in regions, one or more of the plurality of media conduits run between the individual winding sections of the Gramme stator winding.

5. A flexible-tubing motor according claim 1, wherein the flexible-tubing motor is a permanent magnet synchronous motor.

6. A flexible-tubing motor according to claim 4, wherein the individual sections of the Gramme stator winding in each case represent individual coils.

7. A flexible-tubing motor according to claim 4, wherein the stator further includes a yoke ring enclosed radially inwards and/or radially outwards by a coil body of the stator.

8. A flexible-tubing motor according to claim 7, further comprising radial protuberances of the coil body located between the individual sections of the Gramme stator winding.

9. A flexible-tubing motor according to claim 4, wherein the media conduits are conduits for leading through light, water, non-compressed air, compressed air, or electrical current.

10. A flexible-tubing motor according to claim 1, wherein a ratio of the largest extent (Dₛₜₐₜₒᵣ) of the stator radially to the shaft, to the greatest extent (Iₛₜₐₜₒᵣ) of the stator in the direction of the shaft, is between 0.8 and 5.

11. A flexible-tubing motor according to claim 10, wherein the ratio of the largest extent (Dₛₜₐₜₒᵣ) of the stator radially to the shaft, to the greatest extent (Iₛₜₐₜₒᵣ) of the stator in the direction of the shaft, is between 1.2 and 1.6.

12. A flexible-tubing motor according to claim 1, wherein a ratio of the greatest extent (Dₛₜₐₜₒᵣ) of the stator radially to the shaft, to the greatest length (I_{rotor magnet}) of the rotor magnet in the shaft direction, is between 1 and 6.

13. A flexible-tubing motor according to claim 12, wherein the ratio of Dₛₜₐₜₒᵣ to I_{rotor magnet}, is between 1.6 and 1.8.

14. A flexible-tubing motor according to claim 1, further comprising a housing, wherein a ratio of a length of the housing of the flexible-tubing motor from an abutment of the coupling for coupling the dental instrument, up to an opposite end of the housing on the flexible-tubing side, to a largest radial dimension of the housing of the flexible-tubing motor, is between 55/19 and 30/23.

15. A flexible-tubing motor according to claim 14, wherein the ratio of the length of the housing of the flexible-tubing motor from the abutment of the coupling for coupling the dental instrument, up to the opposite end of the housing on the flexible-tubing side, to the largest radial dimension of the housing of the flexible-tubing motor, is between 45/19 and 40/23.

16. A flexible-tubing motor according to claim 1, further comprising a housing, wherein a ratio of a length (I_{G}) of the housing from a connection of the motor to the coupling for coupling the dental instruments, up to an opposite end of the housing on the flexible tubing side, to a largest radial dimension (D_{G}) of the housing of the flexible-tubing motor, is between 80/19 and 45/23.

17. A flexible-tubing motor according to claim 16, wherein the ratio of I_{G} to D_{G} is between 65/19 and 60/23.

18. A flexible-tubing motor according to claim 1, wherein the motor is configured to generate torque, at a rotational speed range between 10 r.p.m. and 50000 r.p.m, continuously exceeding 1 Ncm.

19. A flexible-tubing motor according to claim 1, further comprising a housing, wherein a largest diameter (D_{G}) of the housing of the flexible-tubing motor is between 19 and 23 mm.

20. A flexible-tubing motor according to claim 1, further comprising a housing and a guide sleeve connected to the housing, wherein a greatest length (I_{G}) of the housing of the flexible-tubing motor from an abutment edge of the coupling for coupling the dental instrument, up to an opposite end of the housing, is between 30 and 55 mm, and wherein a greatest length (I_{F+G}) of the housing from the abutment edge of the coupling for coupling the dental instrument, up to an end of the guide sleeve connected to the housing, is between 45 and 80 mm.
